(19) United States
(12) Patent Application Publication
(10) Pub. No.: US 2025/0190889 A1
(43) Pub. Date: Jun. 12, 2025

(54) MULTI-MODE USER INTERFACE FOR JOB ORDERS

(71) Applicant: Uber Technologies, Inc., San Francisco, CA (US)

(72) Inventors: Rafael Conte, San Francisco, CA (US); Ehsan Yousefzadeh, San Francisco, CA (US); Shahrouz Takyar, San Francisco, CA (US); Jaeyong Sung, San Francisco, CA (US); Yijin Wu, San Francisco, CA (US); Yiming He, San Francisco, CA (US); John Marsh, San Francisco, CA (US); Guang Xu, San Francisco, CA (US)

(21) Appl. No.: 18/622,752

(22) Filed: Mar. 29, 2024

Related U.S. Application Data
(60) Provisional application No. 63/607,018, filed on Dec. 6, 2023.

(51) Int. Cl. G06Q 10/0631

(52) U.S. Cl. CPC G06Q 10/06311

(57) ABSTRACT

A system, non-transitory computer-readable medium and computing device to communicate, over one or more networks, with a network system to receive job order data for a plurality of job orders. The job order data includes each of service information for each of the plurality of job orders, and one of multiple priority designations associated with each of the plurality of job orders. A user interface is provided to display the service information for each of the job orders. The user interface can be provided in one of multiple modes, including (i) a focus mode in which service information for one job order is pre-selected and displayed based on the priority designation of that job order; and (ii) a browse mode in which the service information for multiple job orders are displayed at one time or made available to the user.

### RELATED APPLICATIONS

This application claims benefit of priority to provisional U.S. Patent Application No. 63/607,018, filed Dec. 6, 2023; the aforementioned priority application being hereby incorporated by reference in its entirety.

### TECHNICAL FIELD

Examples include a multi-mode user interface for job orders.

### BACKGROUND

Under conventional approaches, on-demand services distribute service requests (e.g., transport requests) as job orders. Job orders can be of different types, based on their distribution mechanism and/or response protocol. For example, job orders can be exclusively provided to service providers on a one-to-one basis. Non-exclusive job orders, on the other hand, can be offered to multiple service providers at one time. Still further, some types of job orders (e.g., exclusive job orders) may require the matched service provider to respond affirmatively in order for the job order to be automatically assigned to that service provider. Non-exclusive job orders, on the other hand, may receive multiple response communications from multiple service providers at one time. Still further, some job orders may require no response from the service provider unless the service provider does not want to accept the job order.

Typically, service providers operate mobile devices to receive and respond to job orders. A network system matches service providers to job orders, and communicates job orders to matched service providers. Service providers use a service application executing on their respective mobile devices to receive and respond to job orders. Under conventional approaches, different interactive frameworks are used to communicate job orders of different types. Further, conventional approaches do not account for a service provider's environment. For example, service providers have limited resources to view and evaluate job orders while they are operating a vehicle.

### BRIEF DESCRIPTION OF THE DRAWINGS

FIG. 1A illustrates a network system for matching drivers to service requests, according to one or more examples.

FIG. 1B illustrates a job order handling system for presenting job orders on a unified user interface of a provider device, according to one or more examples.

FIG. 2A illustrates an example method for a network system to transmit job orders to a provider device, according to one or more examples.

FIG. 2B illustrates an example method for providing a multi-modal user interface on a provider device, according to one or more examples.

FIG. 3A through FIG. 3V illustrate examples of a user interface for presenting job orders on a user device, according to one or more examples.

FIG. 4 is a block diagram that illustrates a network system for use with one or more embodiments.

FIG. 5 is a block diagram illustrating an example user device for use with examples as described.

### DETAILED DESCRIPTION

Examples provide for a unified framework to enable service providers to view and respond to job orders in connection with an on-demand service provided through a network system. The unified framework enables service providers to view and evaluate multiple job orders of different types (e.g., exclusive, non-exclusive). Further, the unified framework enables service providers to respond to job orders in a particular manner that is designated for the type of job order. The framework enables a network system to distribute a greater number of job orders of different types to available service providers at one time, thereby increasing the throughput and efficiency of the network system. Further, the unified framework facilitates service providers in evaluating and responding to job orders, further enhancing their efficiency in using their mobile devices with the on-demand service provided by the network system.

In examples, the unified framework is provided in part through a service application that executes on a provider device to provide a multi-modal user interface. The user interface can be implemented to visualize job orders of different types on a common interface that can include map content. Further, the user interface can be selectively implemented in a focus mode automatically in instances when the service provider is operating a vehicle. In such cases, the user interface can be implemented to pre-select individual job orders for the service provider.

According to examples, a system, non-transitory computer-readable medium and computing device are provided to communicate, over one or more networks, with a network system to receive job order data for a plurality of job orders. The job order data includes each of service information for each of the plurality of job orders, and one of multiple priority designations associated with each of the plurality of job orders. A user interface is provided to display the service information for each of the job orders. The user interface can be provided in one of multiple modes, including (i) a focus mode in which service information for one job order is pre-selected and displayed based on the priority designation of that job order; and (ii) a browse mode in which the service information for multiple job orders are displayed at one time or made available to the user.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Still further, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### Network System

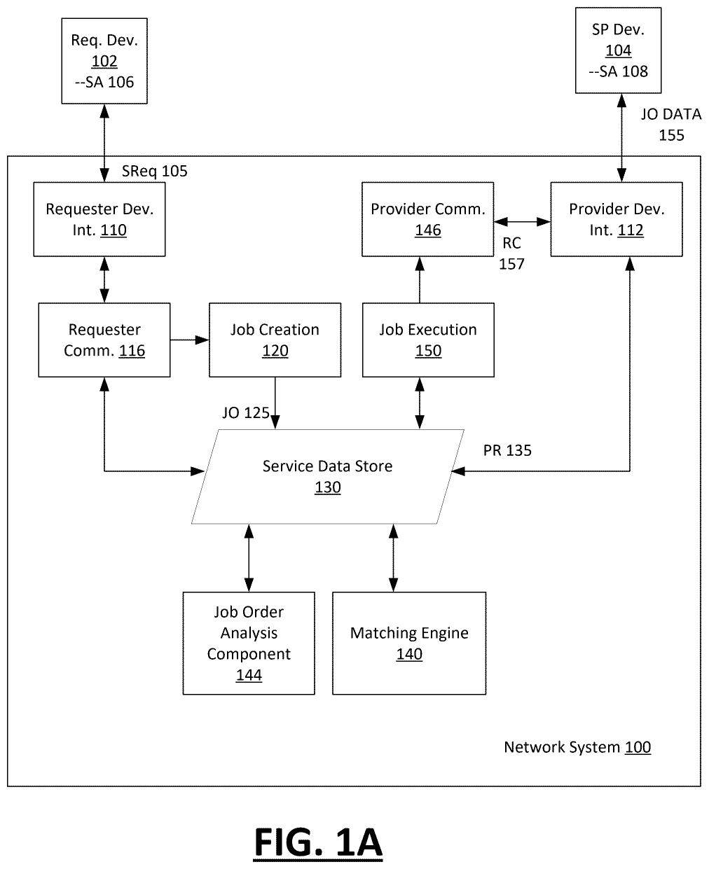

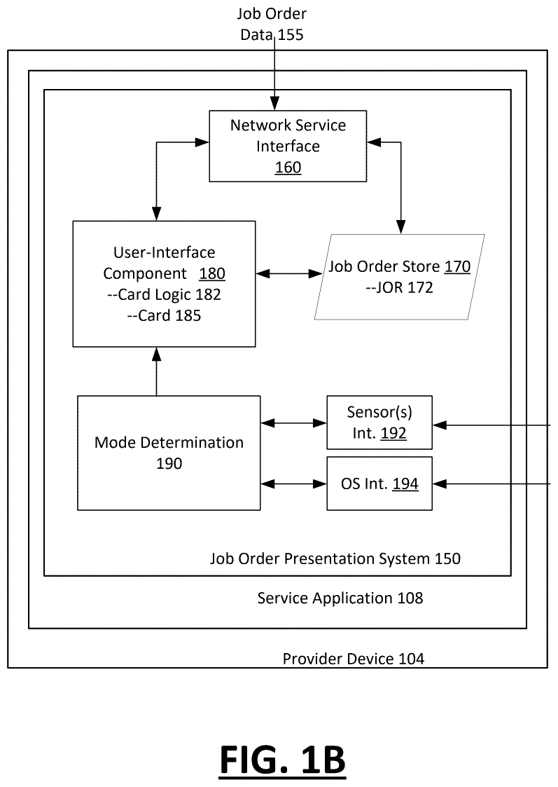

FIG. 1A illustrates a network system for matching drivers to service requests, according to one or more examples. In some examples, a network system 100, as illustrated with FIG. 1A, enables a network platform in which users operate mobile computing devices of users access or implement functionality to facilitate the user's participation and use of a matching service. In examples, the users of the network system 100 include service providers (e.g., drivers who operate their own vehicles to transport riders) and requesters (e.g., riders who request and receive transport services from drivers). The transport service provided by the service provider may include a service in which the service provider operates a vehicle to transport the requester from a service start location (e.g., pickup location) to a service end location (e.g., destination or drop-off location). In variations, examples described with the network system 100 can be applied to other types of transport services, such as, for example, group transport (e.g., rider has friends or family who accompany the rider on the trip), pooled transport (e.g., driver picks up additional riders who separately request the transport service, typically with different pickup locations and/or drop-off locations), bus transport (e.g., driver transports multiple riders in large-capacity vehicle, sometimes while following a pre-determined route), or delivery transport (e.g., service provider picks up and delivers an item).

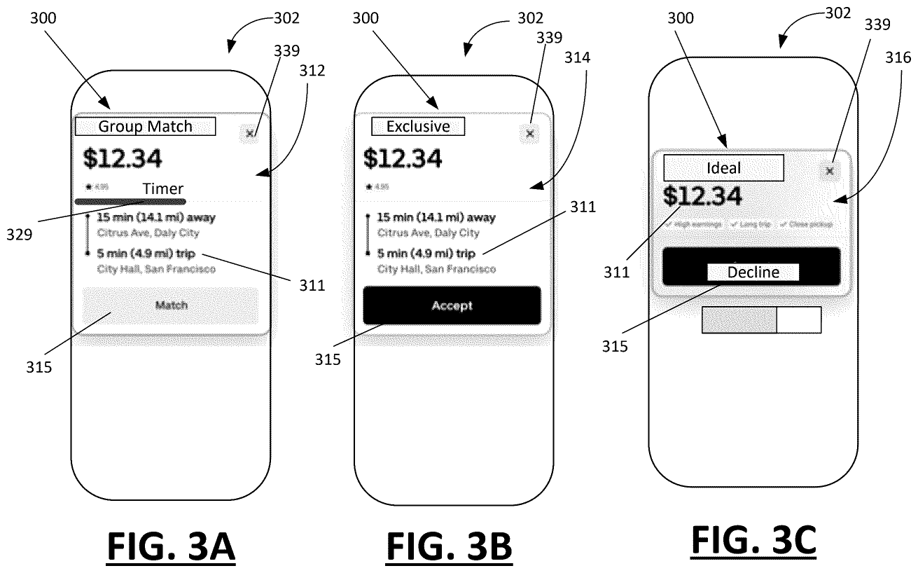

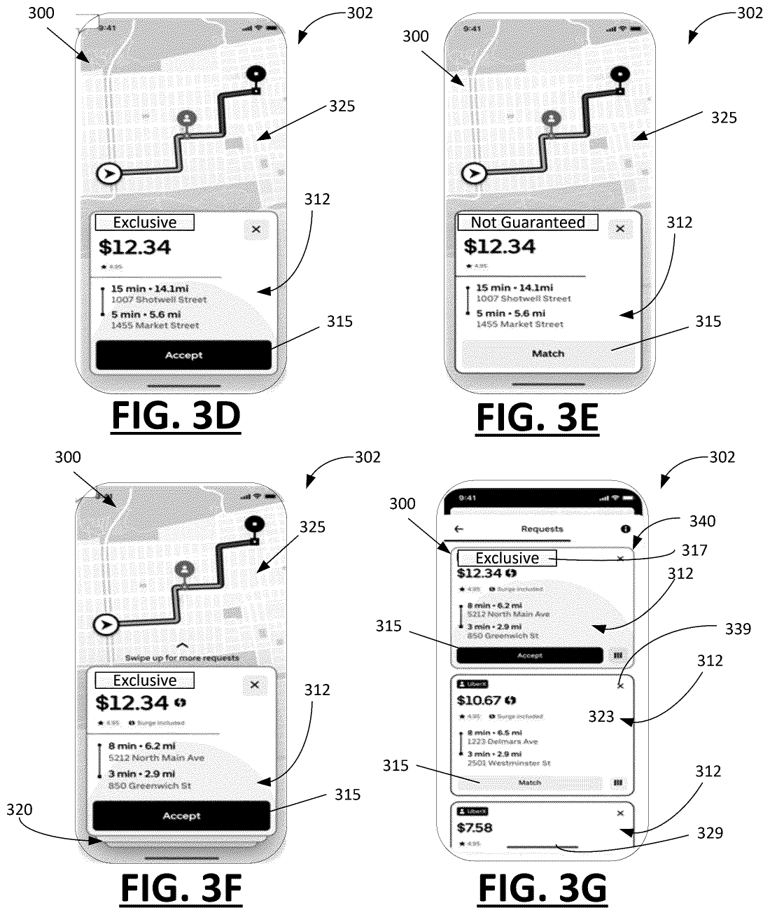

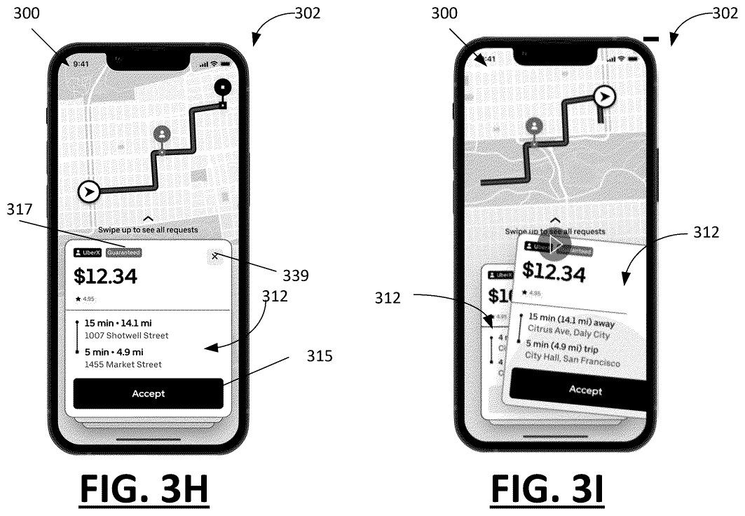

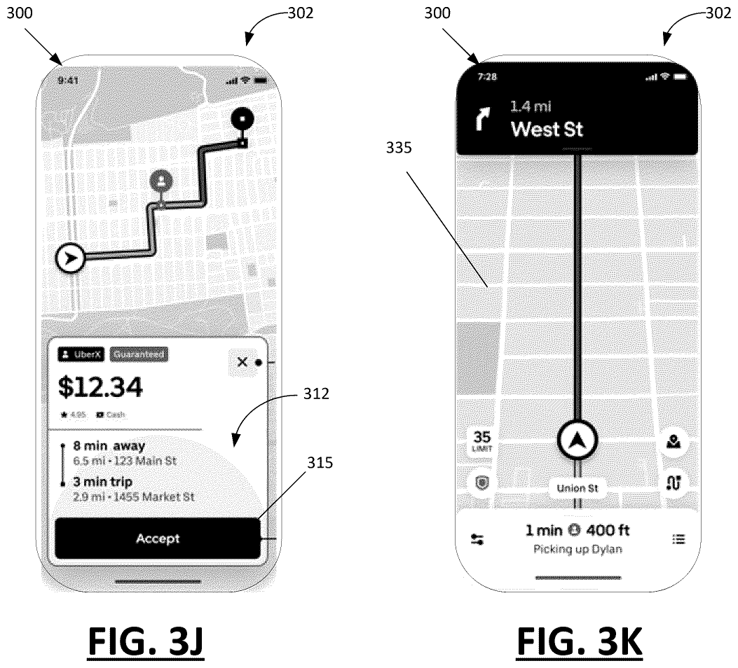

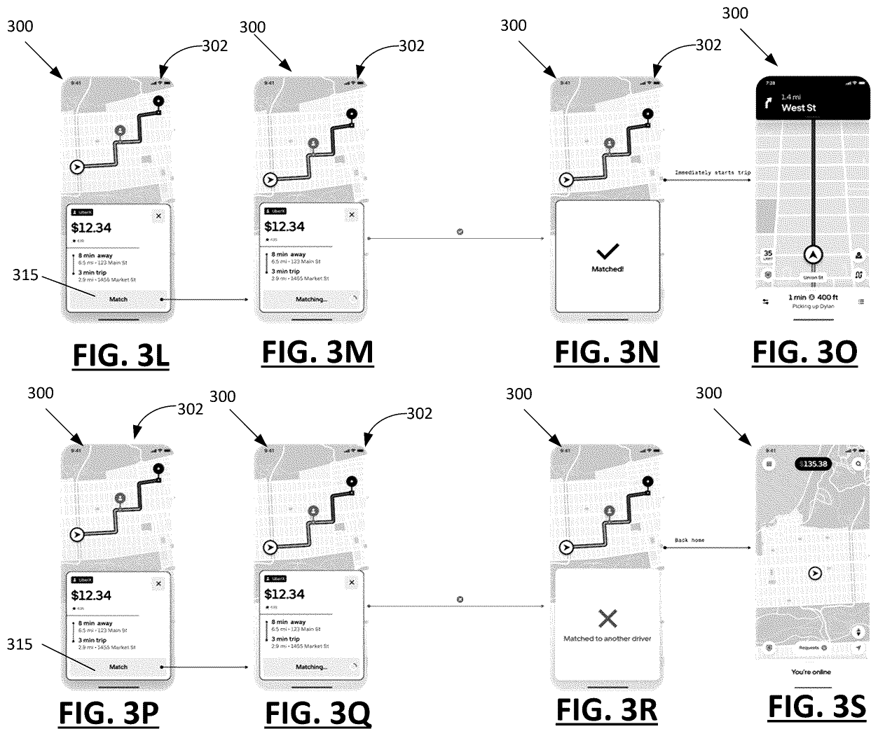

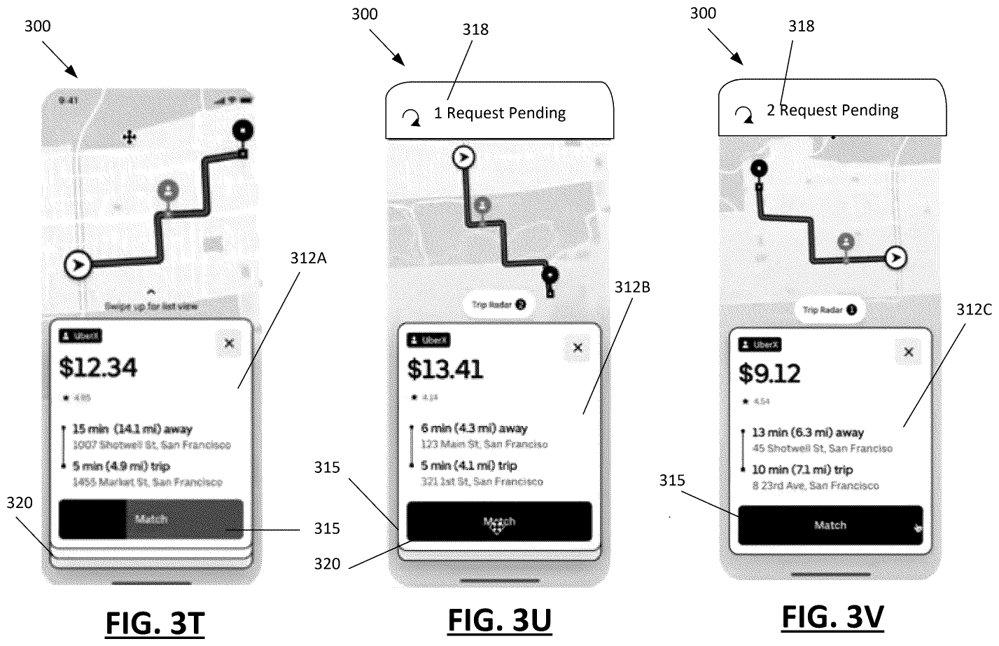

With reference to FIG. 1A, the network system 100 includes a requester device interface 110, a provider device interface 112, a requester communication component 116, a job creation component 120, a service data store 130, a matching engine 140, a job order analysis component 144, and a job execution component 150. Each service requester can operate a corresponding requester device 102 to utilize the network system 100. In examples, each requester can operate a service application 106, running on the corresponding requester device 102, to access information, generate service requests and receive services from the network system 100. Likewise, service providers can operate service applications 108 running on corresponding provider device 104 to make themselves available to the network system 100 as a resource or source for fulfilling service requests of requesters. Further, as described with examples below (e.g., see FIG. 3A through FIG. 3V), service providers can operate respective service provider devices 104 to view, select, accept, dismiss or otherwise respond to matched job orders.

In examples, the requester device interface 110 represents processes that communicate with requester devices 102 to enable requesters to use services provided through the network system 100. The requester device interface 110 can communicate with requester devices 102 to receive service requests 105, receive information from requester devices 102, and provide information to requester devices 105, in conjunction with services provided through the network system 100. In examples, the requester device interface 110 receives transport-related service requests 105 from requester devices 102. The service requests 105 can specify parameters and other information for transporting a requester, designee, or object (e.g., package, food order, grocery, etc.). In context of transportation services, the service request 105 can specify service information that includes a service start location (e.g., pickup location) and a service end location (e.g., destination). Other service information that can be included with the service request 105 can include, for example, a service type (e.g., type of vehicle the requester would like to be transported in), the current location of the requester, and timing information (e.g., a specific time the requester would like to be picked up or arrive at their destination, an urgency of the service request, etc.). The types of services provided can also include transport-related services and delivery services (e.g., for food, groceries, or shipments).

The provider device interface 112 represents processes that communicate with provider devices 104 to enable providers to access and provide services through the network system 100. In examples, each service provider can operate a service application 108 on their respective service provider device 104 to make themselves available as a transport provider for requesters of the network system 100. In examples, each service provider makes themselves available as a transport provider by operating a service provider application 108 on their respective device 104. For example, a service provider can open a service provider application 108 and toggle an availability feature to make themselves available. The service application 108 transmits the availability status, along with the provider identifier and their current location to the provider device interface 112.

Once a service provider makes themselves available (e.g., goes “online”), the provider device interface 112 creates (or updates) a corresponding service provider record 135 that reflects a current location and status of the service provider. Subsequently, the provider device 104 can automatically communicate its current location to the network system 100, using the service application 108. Through use of the service application 108, the service provider can receive transport requests, and the service provider may operate a service vehicle to fulfill matched transport requests. Once the communication channel is established, the provider device 104 can automatically communicate service information to the network system 100, at repeated intervals or continuously. The service information may include the provider's identifier and the provider's current location, which may be determined by the service application 108 interfacing with a satellite receiver (e.g., GPS component or other location-aware resource) of the provider device 104.

Further, as described below, once the service provider is available, the network system 100 can match the service provider to multiple job orders. The matched job orders can be of different types or categories (e.g., exclusive versus non-exclusive). The network system 100 can transmit job order data 155 to the requester device, where the job order data 155 enables the provider device 104 executing the service application 108 to present information about the matched job orders to the service provider. The service provider can select matched job orders through interaction with a user interface provided on the provider device 104 through execution of the service application 108.

### Job Order Creation

The job creation component 120 represents processes that create a record, referenced as a job order 125, for each service request 105 received by network system 100 (e.g., via requester device interface 110). Each job order 125 can specify service information of the service request 105, including the service locations of the service request 105 and other service information. Additionally, each job order 125 can specify a job status. In examples, the job status reflects whether a job order is open, pending or assigned. An open status refers to a job order 125 that is presently unmatched to a service provider. An open job order 125 can include newly created job orders for newly received transport requests 105, as well as job orders 125 which were previously matched but not accepted by a service provider. Pending job orders 125 can include job orders that are matched to a service provider, but which have not been accepted by a service provider. As described below, a pending job order can be made exclusively available for acceptance to one service provider for a time interval during which no other service provider can accept the job order 125.

In examples, each job order 125 can also be associated with a distribution type, such as an exclusive or one-to-one distribution versus a group distribution. An exclusive job order is one that is made exclusively available for acceptance (or rejection) during a particular time interval to a single service provider that has been matched to that job order 125. If the matched service provider does not accept the matched job order 125, then the job order 125 may be made exclusively available for acceptance to another matched service provider (e.g., a backup service provider). Alternatively, a job order 125 can be initially made available or changed to a group or non-exclusive type, where the job order 125 can be accepted by any one of multiple service providers that are identified in the group, in accordance with a predetermined set of matching rules.

Accordingly, for each newly received service request 105, the job creation component 120 creates and stores a corresponding job order 125 with the active data store 130, where the status of the job order reflects it has an open status. The service data store 130 can also store service provider records 135 for active service providers. In examples, a status of the service provider can indicate whether the service provider is available or unavailable for matching. An available service provider includes a service provider that has an open status, meaning the service provider (i) does not have a pending job order 125 to accept or decline, and (ii) is not currently assigned to a job order 125. A service provider that has a pending status means the service provider has received a pending job order 125 to accept or decline. A service provider that is unavailable, or has an unavailable status, can include a service provider that accepts a job order 125. Conversely, if a service provider receives a job order 125 and then rejects it, the status of the service provider can change from pending to available.

### Job Order Categorization and Prioritization

In examples, the job analysis component 144 includes processes to analyze and evaluate job orders 125 based on factors such as the desirability of the job order. Based on the analysis, the job analysis component 144 can designate a categorization and/or priority for each job order. In some examples, the prioritization of individual job orders is based on a priority schema that takes into account the type of job order, the service location, the desirability of the job order, the length of time the job order has been open and other factors. Further, the job analysis component 144 can determine a categorization for each job order, where the categorization reflects a type of the job order (e.g., excusive job order, non-exclusive job order, ideal job order, etc.). The determination of the category (or type) for the job order can also reflect a priority of the job order, based on the prioritization scheme. For example, exclusive job orders may be viewed as higher priority than non-exclusive. As an addition or alternative, the priority scheme can take into account characteristics of the job order, such as the service locations and fare amount. Further, as an addition or variation, the prioritization scheme can take into account other factors, such as service provider preferences, tendencies or locations. The job analysis component 144 can designate one or more categories and/or priority designations for individual job orders 125.

In examples, the job analysis component 144 determines a desirability of individual job orders 125 based on parameters such as the service location(s) of the job orders, the likely routes of travel, the time or distance of travel, the estimated fare amount for the service provider, and/or other metrics. The job analysis component 144 can maintain historical information that identifies correlations between characteristics of historical job orders (e.g., service information included with each job order) and outcomes such as the acceptance rate of the job orders. The acceptance rate can include a score, a range, or other probabilistic metric that is indicative of the likelihood that the job order 125 will be accepted during a given time interval. For example, a higher acceptance rate can mean that a job order will likely be accepted by a matched service provider, while the low acceptance rate can reflect uncertainty or a likelihood that the job order 125 will be rejected by a matched service provider.

In examples, the acceptance rate component 144 can determine acceptance rate metrics that are based on characteristics of the job order 125. In such examples, the acceptance rate can be based on characteristics of the job order 125 (e.g., service start location, service destination, fare amount, etc.), inferred characteristics (e.g., likely route taken by service provider) and/or contextual information (e.g., time of day, day of week, month, season, weather conditions, traffic conditions). By way of illustration, job orders 125 that have a particular service start location or route may be more desirable than job orders 125 that have out-of-the-way service start locations. In this way, the acceptance rate component 144 can use historical information to determine acceptance rates for individual job orders 125, based on one or more characteristics of the job order 125.

In variations, the acceptance rate component 144 can utilize service provider information to determine an acceptance rate of a job order 125. In particular, historical information about preferences or tendencies of matched service providers to accept or decline job orders 125 can be used to determine the acceptance rate of individual job orders 125. The historical information of individual service providers can be part of the service provider's profile information, which can be referenced by the service provider record 135.

In some examples, one or more predictive models can be used to determine the acceptance rate of individual job orders 125. For example, one or more stochastic models can be developed for a particular geographic region to predict the likelihood of acceptance of individual job orders 125, where the stochastic models are trained on historical information for the particular geographic region and use input signals that include service locations and/or contextual information.

In some examples, the acceptance rate component 144 determines the acceptance rate for a newly created job order 125 at or about the time the job order is created. In this way, each job order 125 can be associated with an acceptance rate. Based on implementation, the acceptance rate can be binary (e.g., reflecting high or low acceptability), trinary (e.g., reflecting high, neutral or low acceptability), a score (e.g., score between 0 and 1 reflecting a probabilistic value of the job order 125 being accepted), or other determination (e.g., multivariate, conditional, etc.).

In examples, the job analysis component 144 analyzes the service information associated with each job order 125 to determine a matching category for the job order. In examples, the matching category can specify, for example, whether a job order 125 is to be exclusively communicated to one service provider at a time until the job order is accepted, or whether the job order 125 is to be provided to a group of service providers at one time for acceptance by any one of the service providers of the group. In making the determination, the job analysis component 144 can label or otherwise associate the individual job orders with category designations reflecting, for example, “exclusive” or “guaranteed” (e.g., to be provided to one service provider at any given time until acceptance) or “non-exclusive”, “multi-invite” or “group distribution” (e.g., communicated to multiple service providers at one time for acceptance by any of the service providers). The determination of the matching category for individual job orders can be based at least in part on the determined acceptance rate of the job order. For example, when the acceptance rate for individual job order 125 is below a threshold value, the job analysis component 144 can characterize the job order as a group. As an addition or variation, when the acceptance rate for job order 125 is deemed to be greater than a high threshold, such that acceptance of the job order 125 in a relatively short time interval is likely, the job order 125 can be categorized as an ideal job order for matched service provider. Job orders that are deemed to be “ideal” can be exclusively communicated to one service provider, and further subject to acceptance by default by the service provider.

As an addition or variation, the matching category for individual job orders can be based on other determinations relating to, for example, the service providers. For example, the number of service providers available as compared to the number of open job orders can weigh or factor into the determination of the job order's categorization. Further, if available service providers are determined to have a relatively low propensity for accepting job orders, then the job analysis component 144 can weight the categorizations of the open job orders 125 in favor of “non-exclusive”, “multi-invite” or “group distribution”. Still further, in other examples, when an exclusive job order fails to match after several attempts, the job order 125 may be recategorized as non-exclusive in order to increase the probability that a service provider will accept the job order.

### Matching Process

The matching engine 140 implements a matching process to match job orders 125 with service provider records 135. In examples, the matching process can be implemented repeatedly, such as at discrete time intervals (e.g., every 5 or 10 seconds, etc.). Further, in some examples, the matching process may be implemented as a group operation (or group-level matching process), where at each interval, every open job order 125 is matched to an available service provider, or vice-versa. Additionally, the matching engine 140 can optimize matching for one or more objectives, including one or more group or system-level objectives. For example, the matching engine 140 can match open job orders 125 to available service providers based on one or more objectives that include (i) minimizing a total (or group-level) wait time of requesters until pickup, and/or (ii) minimizing a total (or group level) distance traveled by service providers to reach the service start (or pickup) locations. As an addition or variation, the matching engine 140 can optimize the matching process for individual job orders 125 or service providers, such as by matching certain service requests with the service provider that is nearest to the service start location.

In examples as described, the matching engine 140 implements one or multiple different matching processes to match job orders 125 with service provider records 135. The matching processes as a whole can solve one or multiple objective functions, including objective functions to optimize for one or more objectives of the network system 100. For example, the matching engine 140 can implement a matching process that identifies multiple available service providers for individual job orders 125, where each identified service provider furthers the objective(s) of the network system 100 to some degree and more so than other available service providers (e.g., as compared to selection of service providers through a randomized process). The matching process can also rank or prioritize available service providers that are matched to each job order 125 based on the objective(s) of the network system 100. For open job orders 125, the highest ranked service provider can correspond to the matched primary service provider.

In examples, at a given time interval, the matching engine 140 implements one or more matching processes that (i) identify open job orders 125 from the service data store 130; (ii) identify open service provider records 135 from the service data store; and (iii) match each open job order 125 to an open provider record 135 as a primary matched service provider.

During the same interval, examples provide that the matching engine 140 implements a second matching process by (i) identifying pending job orders 125 where a job order 125 has been communicated to a matched service provider; (ii) identifying pending and open provider records 135, reflecting the pool of open service providers who have not received a job order 125, as well as the pool of pending service providers who have received a job order 125 that they have not accepted or declined; and (iii) matching each pending job order 125 to the provider record 135 for one or more service providers that are to be backup for the pending job order 125. In examples, first and second matching processes can be implemented at one time, and/or as one process (e.g., solving the same objective function) during a given interval. In variations, the first and second matching processes can be implemented as different processes during the given interval. For example, the first matching process can be weighted or configured for a first objective (e.g., minimize group wait time), while the second matching process can be weighted or configured for a second and different objective (e.g., improving the likelihood of the job order 125 being accepted).

As described with examples, the matching of a job order 125 to a primary service provider results in the primary service provider exclusively receiving the matched job order 125 to accept or decline. If the primary service provider declines the job order 125, then a predetermined backup service provider can automatically and exclusively receive the matched job order 125, without the matching process being re-performed, without the matching process being re-performed before job order data 155 for the matched job order is transmitted to that service provider. Additionally, a duration provided for a service provider to exclusively receive and accept/not accept a job order 125 can span multiple time intervals during which matching is performed. In that duration, the backup service provider(s) matched to the job order can change, based on the results of the respective matching processes.

In examples, different matching processes can be used for job orders 125 of different categories. For example, for a job order 125 that is categorized as exclusive, a first matching process can be used to match a given job order to a single available service provider based on an objective function of the matching engine 140. For a job order that is categorized as nonexclusive, a second matching process can be used to match the job order to multiple service providers. In the latter case, the matching can select a set of candidate service providers that are within a threshold travel distance or duration from the service start location of the job order. In this way, different matching processes can be carried out by the matching engine 140, based in part on the categorization of the job order 125.

### Job Order Execution

Once matching is performed, processes represented by job order execution component 150 communicate job orders 125 to the computing devices 104 of matched service providers. The job order execution component 150 can transmit job order data 155 to the provider devices of available service providers. The job order data 155 can specify service information for each job order that is matched to a given service provider. The service information can include the service locations specified with the corresponding transport request. The service information can also include the fare amount (or estimated fare amount) for fulfillment of the job order 125. Additionally, the job order data 155 can include categorical designations of individual job orders. In some variations, the job order data 155 can also include prioritization designations of individual job orders 125. Further, in examples, the job order data 155 can be communicated as a data stream, in-app message, push notification or other data transmission which is then received and processed by the provider device 104 through execution of the corresponding service application 108.

In examples, individual service providers may be matched to multiple job orders concurrently, including, for example, one job order that has an exclusive category designation, and/or one or multiple job orders that have a non-exclusive designation. Accordingly, the job order data 155 communicated to each provider device can include service information for multiple job orders. The job order execution component 150 can utilize a provider communication component 146 to transmit the job order data 155 to the computing device 104 of each service provider.

The job order communications 155 can be structured to enable the respective service applications 108 running on the receiving provider devices 104 to display information about the job order 125, such as information about the service locations and fare for fulfillment of the job order 125 (e.g., see FIG. 3A-3V). The job order communications 155 can also include data to cause the receiving provider devices 104 to provide one or more interactive features for enabling the corresponding service provider to accept or decline the job order 125 through input interaction (e.g., screen tap, voice utterance etc.). In response to such provider interaction, a provider device 104 can generate a response communication 157 to a job order communication 155, where the response communication 157 indicates one of acceptance or rejection of the job order. The response communication 157 can include an identifier associated with the service provider and/or the corresponding job order 125.

When the response communication 157 transmitted from a provider device specifies a job order that has a nonexclusive designation, the job order execution component 150 can update the service data store 130 to reflect the corresponding service provider's acceptance of the job order. Further, the job order execution component 150 can trigger the matching engine to implement additional steps for determining whether the job order 125 specified by the response communication 157 is to be assigned to the service provider who accepted the job order. For nonexclusive job orders, the matching engine 140 can implement alternative logic for determining whether a given service provider is to be assigned to the job order after accepting. In examples, the matching engine 140 can wait a given time interval, and if multiple service providers accepted the nonexclusive job order during a time interval, the matching engine 140 determines which service provider is assigned to that job order. The determination can be based on, for example, (i) the service provider the first accepted the nonexclusive job order, (ii) the service provider who is closest (by distance or time of travel) to the service start location of the nonexclusive job order, (iii) the service provider that would, if assigned to the job order, best further the optimization objectives of the network system 100, and/or (iv) the service provider who has had the longest wait time for a job order assignment.

When the response communication 157 specifies a job order that as an exclusive designation, the job order execution component 150 can update the service data store 130 to reflect the corresponding service provider's acceptance of the job order. The job order execution component 150 can automatically assign the job order 125 to that service provider with no further steps. Thus, the status of the service provider can be changed to the assigned, the status of the job order 125 can also be changed to closed, and further communications with the service provider can be in the form of navigational content and/or other information for facilitating the service provider in completing the transport request.

In some examples, the provider communication component 146 can also receive activity data from the provider devices, where the activity data reflects the user's interactions with individual job orders, as visualized on the respective service provider device. The activity data can reflect, for example, whether the service provider viewed a job order or dismissed the job order without accepting the job order.

Still further, in examples, the matching engine 140 implements matching processes repeatedly, such as in set time intervals (e.g., every 30 seconds, etc.). With performance of matching, the job order execution component 150 can update the matching job orders on individual service provider devices. In the event the matching identifies a particular job order that the service provider has reviewed or dismissed (e.g., based on activity data received from the provider device), the job order execution component 150 can filter out the particular job as an addition or variation, the matching engine 140 can perform the matching to exclude the service provider from being rematched to a job order 125 that the service provider has previously dismissed or viewed and not acted upon.

In some examples, the job order data 155 is transmitted repeatedly at set time intervals to service provider devices 104. In this way, the service providers receive non-exclusive job orders at the same time, giving each service provider an equal opportunity to evaluate non-exclusive job orders.

FIG. 1B illustrates a provider device that implements a job order handling system, according to one or more examples. In examples, a job order handling system as described with an example of FIG. 1B can be implemented by a service application 108 running on a provider computing device 104. Still further, a job order handling system 150 as shown with FIG. 1B can be implemented as part of an integrated platform that includes the network system 100. Further, as described with examples, the job order handling system 150 provides a unified framework to enable service providers to receive and respond to job orders of different types (e.g., job orders with different categorical or priority designations).

In examples, the job order handling system 150 includes a network service interface 160, a job order store 170, a user interface component 180, and mode determination component 190. The network service interface 160 received job order data 155 from the network system 100. The job order data 155 can specify job orders 125 that have been matched to the user (or provider) of the device 104. The job order data 155 can include service information for each of the matched job orders, as well as a categorical designation of the individual job orders. The categorical designations can include designations reflecting whether the job order is exclusive or nonexclusive, as well as other designations such as whether the job order is ideal. The network service interface 160 can identify job order records 172 from the received job order data 155. The job order records 172 can be stored in a job order store 170 on the provider device 104.

The user interface component 180 retrieves job order records 172 from the job order 170. The user interface 180 generates a visualization construct for each job order record 172. In examples, the user interface component 180 implements card logic 182 to generate an interactive card 185 for each job order record 172. A card 185 corresponds to a user interface element having a defined structure or dimension that is generated for a service application, and represents a corresponding service request. In variations, other visualization constructs can be used to represent the job orders. For example, the job order records 172 can be displayed as tiles, panels, objects etc. In examples, each card 185 can be rendered as an object that the service provider can interact or manipulate. Each card 185 includes service information for the corresponding job order, including, for example, the service locations of the job order and an expected fare amount for completing the job order. Individual cards 185 can also include a response feature (e.g., response feature 315 of FIG. 3A through FIG. 3V) to enable the service provider to provide a response communication with respect to the matched job order represented by the card 185. In examples, the user interface 180 enables the service provider to interact with the cards 185 through any one of multiple input features, including the response feature, a close or dismissal feature (e.g., dismissal feature 319 of FIG. 3A through FIG. 3V) and/or an interactive input logic to interpret a user action with respect to the card 185 (e.g., swiping the card).

According to examples, the user interface 180 can be implemented to have multiple modes, where each mode configures the manner, context and/or number of cards that are displayed on the provider device 104. In a first or focus mode, the user interface displays only one pre-selected card, and while the mode is in effect, the service provider is unable to navigate to view other cards 185 for other job orders. The service provider can interact with the preselected card 185 through the response communication. In examples, the response feature 315 (see FIG. 3A-3V) is selectable by the service provider to cause the provider device 104 to transmit a communication associated with the response feature of the card 185. In additional examples, the service provider can interact with the presented card of the focus mode to dismiss the card. The dismissal of the card 185 can correspond to the service provider declining the job order. The determination of which card 185 to display can be based on a prioritization schema. The prioritization can be based in part on the categorization designation of the job order associated with the individual cards. In some implementations, the card 185 that represents a job order with an exclusive designation has the highest priority amongst the cards of the job order records 172, The card 185 with the highest priority designation can be pre-selected automatically for display when the user interface 180 is in the focus mode. As an addition or variation, the prioritization designation can be based on other characteristics or attributes of the job orders. For example, priority designations amongst at least some of the cards 185 can be based on the proximity of the service start location of the job order to the current location of the service provider. Thus, the priority designation or schema can be determined by either the network system (e.g., by default) or by the provider device 104 (e.g., based on settings, preferences, or tendencies of the service provider).

In a second mode (or browse mode), the user interface 180 enables the service provider to view and interact with multiple cards 185 while the user interface is in that mode. The cards can also be arranged in constructs such as a stack or list. When the cards 185 are arranged in a stack, the service provider can view individual cards 185 one at a time by navigating through the stack. When the cards 185 are arranged in a list, the service provider can view and select to interact with multiple cards at one time. Further, the service provider can scroll through the list to view and select cards for interaction.

In one implementation, the service provider can view cards in a stack, one at a time, with the highest priority card 185 being surfaced at the top of the stack. Subsequent cards 185 in the stack can also be arranged by priority. For example, the service provider can swipe or dismiss the top card of the stack to view the card 185 that has the next highest priority designation. Further, the service provider can navigate from one card to the next.

The mode determination component 190 evaluates one or more input signals to determine whether a condition for a particular mode or mode switch exists. In examples, the focus mode can be implemented in conditions when the service provider is driving or otherwise distracted. The mode determination component 190 can monitor input signals to detect when the service provider is moving within a vehicle (or driving), or moving/driving above a threshold speed (e.g., 10 MPH). The mode determination component 190 can receive input signals from (i) the operating system of the computing device, (ii) movement sensors (e.g., accelerometer, gyroscope, IMU, etc.), and/or (iii) satellite receivers for location determination. The 190 can include or communicate with one or more multiple interfaces 192, 194 to receive the input signals.

In examples, the user interface 180 can implement by default the browse mode. When the mode determination component 190 detects a condition that is indicative of the service provider operating the vehicle, the mode determination component 190 automatically implements the mode switch, and the user interface 180 is switched from browse mode to focus mode. Further, within the browse mode, the service provider can interact with the user interface 180 to select between a stack mode (where the cards are arranged in a stack) or a list mode (where the cards are arranged in a list form that is navigable. In the stack mode, the cards 185 can be arranged in a stack.

The use-interface 180 can also enable individual cards 185 of different types to be viewed with map content that depicts service information about the associated job order. In the focus mode, for example, the selected card 185 can be integrated with map content that displays a route between a current location of the service provider and the service start location, and/or between the service start location and the service end location. As an addition or variation, the map view can display information indicating a distance or time of travel from the service provider's current location to the service start location and/or from the service start location to the service end location. Likewise, in the browse mode (e.g., when the cards 185 are presented in stack form), the map content can display map content illustrating service information (e.g., service start and end locations, route information, distance or time of travel, etc.). Among other advantages, when cards 185 are arranged in stacks, the amount of display space available to the user interface is conserved, and map content can be displayed similar to the focus mode.

Further, in examples, when the service provider navigates through cards in the stack, the map content can be automatically updated to reflect service information (e.g., service start and end locations, route information, distance or time of travel, etc.) for the newly surfaced card. Still further, in examples, the map content can be dynamically rendered. For example, the routes of the user can be animated, dynamically highlighted or visualized (e.g., showing movement along or with the route).

With further reference to FIG. 1B, the user interface component 180 can provide cards with response features that enable the service provider to send a type of response specific to the type or category of the job order. For example, the response communication for an exclusive job order can enable the service provider to accept the job order. Upon the service provider accepting the job order, the network system 100 can automatically assign the job order to the service provider. The response feature for a non-exclusive job order can enable the service provider to provide an acceptance that is conditional, subject to responses from other service provider and selection from the network system 100. For some types of job orders (e.g., ideal or highly desired, with high acceptance rate etc.), the response feature of the card may enable the service provider to decline the job order, otherwise by default, upon expiration of a time interval, the job order is assigned to the service provider. In this way, the response feature provided with the cards of different types can be visually and/or functionally distinct.

Still further, in examples, the user interface component 180 can record specific interactions (“activity data”) the service provider has with individual cards 185. For example, the user interface component 180 can record instances when the service provider views a card (without interacting with the response feature), navigates to a different card, or dismisses a card.

In examples, the user interface component 180 communicates response communications and activity data to the network service interface 160. In turn, the network service interface 160 transmits the response communications and activity data to the network system 100.

Further, in examples, at set time intervals, the network service interface 160 can receive additional sets of job order data 155 from the network system. The user interface component 180 can refresh the cards 185 to reflect updated job order records 172 provided by the most recent job order data 155.

### Methodology

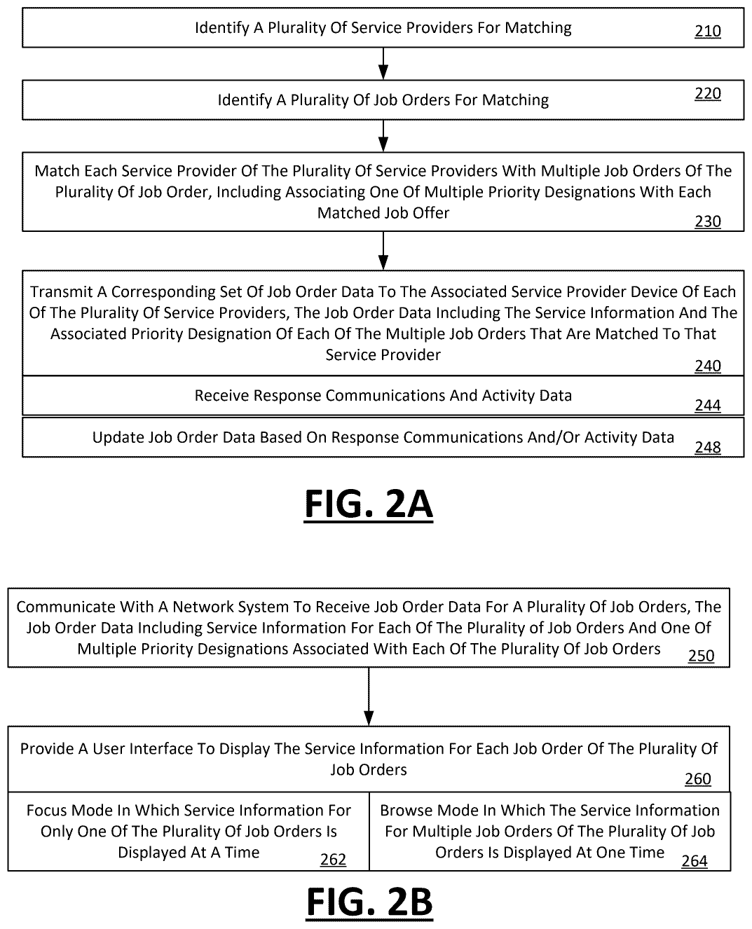

FIG. 2A illustrates an example method for a network system to transmit job orders to a provider device, according to one or more examples. FIG. 2B illustrates an example method for providing a multi-modal user interface for handing job orders on a provider device, according to one or more examples. In describing examples of FIG. 2A and FIG. 2B, reference is made to elements of FIG. 1A and FIG. 1B for purpose of illustrating suitable components or functionality for performing a step or sub-step being described.

With reference to FIG. 2A, in step 210, the network system 100 identifies a plurality of service providers for matching. The service providers include open or available service providers. The determination can be based on, for example, status information associated with the service provider records 135 of the service data store 130.

In step 220, a plurality of job orders are identified for matching. The identified job orders can be open or unmatched job orders, based on, for example, newly received transport requests.

In step 230, the network system 100 matches each of the plurality of service providers to multiple job orders of the plurality of job orders. Each job order can also be associated with one of multiple priority designations. In some examples, the priority designations can be based on a categorization of individual job orders. For each service provider, examples provide that the matched job orders include one job order that has a priority designation, and multiple job orders that have a non-exclusive designation.

In step 240, the network system 100 transmits a corresponding set of job order data to the associated service provider device of each of the plurality of service providers. The transmitted job order data can include service information and the associated priority (or category) designation of each of the multiple job orders that are matched to that service provider.

In some examples, the network system 100 monitors and receives, in step 244, response communications and activity data from the provider devices. The response communications can include the service provider accepting, selecting or not accepting individual job orders. The activity data can include data generated by the provider device 104, where the data indicates the service provider interacted with or viewed the job order, but did not provide a designated response communication (e.g., via the response feature 315 (see FIG. 3A-3V). In step 248, the network system 100 updates the job order data 155 transmitted to the individual provider devices based at least in part on the response communications and/or activity data. For example, the updated job order data 155 can remove, or filter out job orders which the service provider has dismissed or viewed. As an addition or variation, the updated job order data 155 can exclude matched job order(s) that the service provider dismissed, or indicated a lack of interest in. The determination can be made based on the response communication from the respective provider devices 104. As an addition or variation, the determination can be made based on activity data transmitted from the provider device 104, such as activity data that indicates the service provider viewed information about a particular job order without taking action.

With reference to FIG. 2B, in step 250, the provider device 104 communicates with the network system 100 to receive job order data for a plurality of job orders. The job order data can include service information for each of the plurality of job orders. Further, the job order data can include priority and/or category designations for each of the plurality of job orders.

In step 260, the computing device 104 provides a multi-modal user interface to display the service information for each job order of the plurality of job orders. The user interface can be implemented in alternative modes to display individual job orders of the plurality of job orders. In step 262, the user interface can be implemented in a focus mode, where service information for one job order is displayed to receive user input or action. In some examples, service information for other job orders is not viewable to the user while the focus mode is being implemented. In step 264, the user interface can be implemented in the browse mode. In the browse mode, the service information for multiple job orders of the plurality of job orders are displayed or made available to the service provider for interaction (e.g., where the service provider can accept or not accept the job order).

### Example Interfaces

FIG. 3A through FIG. 3V illustrate examples interfaces generated by a multi-modal user interface for presenting job orders to service providers, according to one or more examples. Examples such as described with FIG. 3A through FIG. 3V can be implemented by a job order handling system 150 such as described with an example of FIG. 1B. Accordingly, reference may be made to elements of FIG. 1A and FIG. 1B for purpose of illustrating context and functionality.

With further reference to FIG. 3A through FIG. 3V, a user interface 300 is provided on a provider computing device 302 operated by a provider. As described with an example of FIG. 1B, the user interface 300 can be generated by execution of a service application 108. In examples, the user interface 300 presents interactive cards 312 on the computing device 302, where each card 312 provides information about one of the job order that is matched to the user. The user (e.g., service provider) can interact with individual cards 312 to cause the computing device 302 to transmit a response communication to the network system 100. The response communication can communicate, for example, the service provider's interest or intent to fulfill a job order identified by a particular card. The service provider can also interact with cards to close or dismiss them (e.g., via interaction with the close or dismissal feature 319).

FIG. 3A through FIG. 3C illustrate examples of cards 312 for different types of job orders. While examples shown illustrate the types of job orders to correspond to different types of transport services, in variations, the job orders provided through the user interface 300 can encompass job orders for multiple types of on-demand services, such as (i) food delivery service (e.g., where a service provider picks up a food order for a requester at a restaurant or other source, and then delivers the food order to the requester); (ii) grocery delivery (e.g., where a service provider picks up a grocery order, or shops for a grocery item, on behalf of a requester at a store, and then delivers the grocery order to the requester); and/or (iii) package delivery service (e.g., where the service provider picks up a package from a service start location and delivers it to a destination).

In examples, each card 312 includes service information 311, such as the service locations of the job order, route information, trip duration (e.g., estimated time of arrival), distance traveled, and the estimated fare amount for fulfillment of the job order. Each card 312 can also include a response feature 315 for enabling the service provider to provide a response communication to the job order represented by the particular card 312.

In an example of FIG. 3A, the card 312 represents a group match (or non-exclusive) job order. The response feature 315 enables the service provider to select the job order represented by the card 312. In response to the service provider's selection, the computing device 302 transmits a response communication to the network system 100. For a group-matched or non-exclusive job order, the response communication can result in the network system 100 implementing a selection process or to determine whether the service provider is assigned to the particular job order. The determination can be based on whether other service providers who were matched to the same job order provider a response communication at the same time.

With further reference to FIG. 3A, the card 312 can include a timer feature 329 that indicates a time interval remaining for the service provider to accept the job order. In some examples, upon expiration of the timer, the corresponding job order is closed (e.g., assigned or offered to another service provider). In variations, the timer can indicate a time remaining until the card is refreshed. In some examples, only cards for certain types of job orders (e.g., non-exclusive have timers). In variations, the timer feature 329 can be provided for all types of cards 312. Further, in some examples, the network system 100 can synchronize the timer based on, for example, when matching is performed again and/or when the job order data set 155 is to be updated on the provider device 104.

In an example of FIG. 3B, the card 312 represents an exclusive job order. A user can interact with the response feature 315 to cause the computing device 302 to transmit a response communication that accepts the job order represented by the card 312. In response to the service provider's selection, the computing device 302 transmits a response communication to the network system 100 that accepts the job order. In response, the network system 100 automatically assigns the job order to the responding service provider.

In an example of FIG. 3C, the card 312 represents “an ideal” job order, which can be a category designation for job orders which are highly desirable or ones that are deemed as being likely to be accepted by the service provider. A job order such as represented in FIG. 3C can be determined by the network system 100, using, for example, acceptance models that predict a likelihood that a particular provider or any provider will accept or not accept the job order. For such job orders, the network system 100 can implement a default action where, for example, the service provider is deemed to accept the job order unless the service provider provides input to not accept the job order. In FIG. 3C, the response feature 315 can enable the service provider to provide an input to not accept the job order. Otherwise, the network system 100 assigns the job order to the service provider. For such job orders, the card 313 can also integrate the timer 329 (or a different timer) that visualizes to the service provider the amount of time remaining for the service provider to decline the job order.

FIG. 3D through FIG. 3G illustrate different modes for implementing the user interface 300 to present cards representing job orders. In FIG. 3D, the user interface 300 is shown to be implemented in a first or focus mode, which may coincide with the computing device 302 being in movement (e.g., in a vehicle, above a threshold speed, etc.). In an example, when the focus mode is implemented, only one card 312 is presented on the user interface. The options provided to the user are to accept through interaction with the response feature 315, or do nothing, in which case the network system 100 can implement a default action for the user after expiation of a corresponding time interval. In an example of FIG. 3D, the card 312 is presented without providing associated functionality to enable the service provider to view or navigate to other cards (so as to view other job orders). For example, in the focus mode, only one card is presented by the user interface, and the card 312 may be provided without functionality that allow the service provider to view another card. In order to view another card when the focus mode is implemented, the service provider can switch modes through manual input, or through changing the condition that triggers the focus mode. Further, in examples, when the focus mode is implemented for the user interface 300, the card 312 that is presented is pre-selected, where the selection is based on the priority designation associated with the job order of the particular card. In some examples, a service provider may be matched to only one exclusive or guaranteed offer at any particular time. The determination that a job order is exclusive can be based on, for example, the determined acceptance rate of the job order. The categorization of the card 312 can also reflect a priority designation. For example, the user interface 300 can implement a prioritization schema where an exclusive categorization for a job order is also associated with the highest priority designation. When the focus mode is implemented, the user interface 300 pre-selects the job order to present while that mode is active. The determination of which job order to present can be based on the priority designation, which can be based at least in part on the priority designation of the job order, with, for example, the exclusive categorization having the highest priority designation. Alternatively, the determination as to which card has the highest priority designation (for display in the focus mode) can be based on a ranking, or defined by the prioritization schema (e.g., which may be defined by the service provider's preference, etc.).

In FIG. 3E, the user interface 300 is shown to be implemented in the focus mode with the surfaced card 312 representing a job order has a non-exclusive categorization (shown as “not guaranteed”). The user interface 300 can select the card 312 based on a different priority designation being associated with the corresponding job order. Thus, the priority designation for the card 312 can be based on other characteristics of the job order, such as the proximity of the service provider to the service locations.

In examples of FIG. 3D and FIG. 3E, when the user interface 300 is in the focus mode, map content 325 can also be displayed with the card 312, where the map content 325 visualizes a route, one or more service locations of the job order, and the current location of the service provider. Portions of the map content 325 can also be dynamic, so as, for example, to show the route the service provider would take to fulfill at least a portion of the job order represented by the pre-selected card in animated form.

FIG. 3F illustrates an example of the user interface 300 being implemented in a browse mode, with the cards 312 that represent matched job orders of the service provider being arranged in a stack 320, according to one or more examples. In an example, the browse mode can be implemented in response to a determination that the service provider is not operating a vehicle in motion (or a vehicle having a speed that is less than a threshold speed). As an addition or variation, the browse mode can be implemented by default unless the job order handling system 150 detects a condition such as the computing device 302 being in movement, being in a moving vehicle and/or being operated by a service provider operating a vehicle. In the browse mode, the user interface 300 can arrange individual cards 312 into a stack 320. The stack 320 can be an interactive feature that orders or sequences cards 312, where, for example, only one card 312 is visible at a time and the service provider can interact with the stack 320 and/or cards 312 to navigate and surface different cards 312 to the top of the stack 320.

Accordingly, the stack 320 can enable each card 312 to be accessible to the service provider with navigation input, and without the service provider having to change modes. For example, the cards 312 can be ordered or sequenced based on their respective priority designation (e.g., with the card 312 for the highest priority designation job order on top). Further, the stack of cards 312 can be visually layered so that the service provider can view the service information for only one card 312 (the top card) at a time. To navigate the cards 312, the service provider can swipe, tap or provide another interaction with respect to the top card of the stack. Thus, for example, through a series of swiping, the service provider can navigate to the card 312 that was bottom-most before the service provider started swiping. Additionally, cards 312 can be arranged in the stack such that the response feature 315 of only one card (i.e., the top card) is accessible at any particular time. Thus, the service provider can interact with only one card 312 at a given instance. In this way, the stack 320 allows the cards 312 to be accessible while occupying less space on a display screen of the computing device 302. Through use of the stack 320, examples provide that the user interface 300 can conserve display area for purpose of displaying map content 325.

In examples, the map content 325 can visualize a route and/or service locations of the job order, based on the job order information of the visible card 312. As the service provider navigates (e.g., swipes) to additional cards in the stack 320, the map content 325 can change to reflect service locations and information of the card 312 that is presently visible. In this way, the map content 330 can be updated and changed as the service provider goes through the individual cards. Further, the user interface 300 can synchronize the map content 330 (e.g., the route and/or service locations displayed) with service information displayed for the visible card 312 that is visible, such that the map content 325 is dynamically updated to reflect the service information of the visible card 312 in the stack 320.

FIG. 3G illustrates an example of the user interface 300 being implemented in a browse mode, with the cards 312 that represent matched job orders of the service provider being arranged in a list 340, according to one or more examples. In examples, the list 340 can be scrollable, such that the service provider can view the service information 311 and categorization 317 provided with multiple cards 312 at one time. Additionally, in examples, response feature 315 of multiple cards 312 can be made available at one time. Likewise, the close feature 339 of multiple cards 312 can also be made available to the service provider at once. In an implementation shown by FIG. 3G, the service provider can view service information and categorizations 317 for multiple job orders represented by two cards 312 at one time, and then interact with the response feature 315 of either card to communicate acceptance (or nonacceptance) and/or interest in the representative job order. Further, the service provider can view the timer feature 329 for individual cards in the list 340. Additionally, the service provider can interact with the user interface 300 to scroll in view additional cards 312.

While examples illustrate the rendering of multiple cards 312 in stack and list form, in variations, alternative constructs can be used to visualize and make available multiple cards 312 for the service provider to view and interact with. For example, the user interface 300 can utilize a hybrid construct that includes multiple stacks, with each stack including one or multiple cards 312, each of which a job order. In such an example, each stack can provide card(s) 312 for job orders of a particular category, or cards that are sorted by other characteristics of the represented job order (e.g., fare amount, distance of travel, etc.).

FIG. 3H and FIG. 3I illustrate another example of the user interface 300 arranging cards 312 in a stack 320, according to one or more examples. In FIG. 3H, the service provider interacts with a top card 312 of the stack 320 by swiping. In an example shown by FIG. 3I, the swiping action is shown to cause the second card 312 in the stack 320 to be surfaced or made the visible top card on the stack 320. The swiping action be used to enable the service provider to view a next card without dismissing the card that was previously dismissed. To dismiss the card, the service provider can interact with the close or dismissal feature 339. Alternatively, the swipe feature can also be used to dismiss (e.g., not accept) a surfaced card 312. To accept, the service provider can interact with the response feature 315.

As described with examples, each card 312 of the stack 320 can represent a group-matched or non-exclusive job order of the service provider, and the individual cards 312 can be sequenced or ordered within the stack based on a prioritization schema. The card 312 with the highest prioritization may, by default, be pre-selected to be surfaced (or made visible) on the top of the stack 320. As described, the service provider can provide input (e.g., swipe) to view the next card 312 in the stack 320, where the next card 312 corresponds to the card having the job order with the next highest priority.

In examples, the prioritization schema can be based in part on the category designation of the job order represented by the card 312. The card 312 can include a categorization label 317 that identifies the category or prioritization designation of the represented job order. For example, a card representing a job order that is characterized as being guaranteed or exclusive to the particular service provider may have the highest priority designation amongst all of the active cards 312 on the device 302. The high priority designation may be based on an assumption that guaranteed or exclusive job orders are the most attractive to service providers, as the only need to accept the job order in order to have the job order assigned to them. Further, as described with FIG. 1A, the network system 100 may evaluate job orders for desirability to the service provider before categorizing them as exclusive or guaranteed. Thus, the schema used to determine the priority of individual cards 312 may be predetermined by network system 100, and/or based on the network system's categorization of the job order (e.g., exclusive/guaranteed, group/non-exclusive, ideal, etc.). In variations, the schema used to determine the priority of individual cards 312 may be based on preferences or designations of the service provider. For example the service provider may have a preference to prioritize the cards 312 that form the stack 320 based on the fare amount or the service locations specified by the represented job order.

In examples, a service provider can interact with individual cards 312 in a variety of ways. The service provider can interact with the response feature 315 of individual cards to communicate, for example, acceptance or not acceptance, depending on the category or type of job order (e.g., exclusive versus ideal). In some examples, the service provider can also interact with individual cards 312 to dismiss them, or to view the next card 312 in the stack without dismissing the card 312 that was just on top (e.g., so the service provider can evaluate more than one card 312 before making a selection). For example, as shown with FIG. 3H and FIG. 3I, the service provider can swipe in a given direction (e.g., left-to-right) to dismiss the surfaced card 312. Depending on implementation, input to dismiss a card can communicate that the service provider had declined to accept the job order of the dismissed card, or the service provider has viewed the card and is considering the job order of another card.

Still further, a service provider can interact with a card 312 by closing it. A close feature 339 can be provided with individual cards 312 to enable the service provider to close the card. The act of closing a card 312 can dismiss the card 312, meaning the service provider declines to accept or select the card. In response to the service provider providing input to dismiss the card 312 (e.g., via the close feature 339), the device 302 may communicate the dismissal to the network system 100, which in turn updates the matching process to, for example, make the job order represented by the card 312 available for matching to another service provider (e.g., in the case where the job order is exclusive). Additionally, dismissing a card can cause the network system 100 to replace the job order with another by, for example, refreshing the job data communicated to the device 302 after matching is reperformed at a subsequent interval.

FIG. 3J and FIG. 3K illustrate a sequence where the user interface is implemented in the focus mode, and the service provider accepts the job order represented by the presented card 312 via interaction with the response feature 315. According to some examples, in the focus mode, only one card 312 may be available for viewing and interaction to the service provider. FIG. 3J illustrates that prior to a service provider's interaction with the card 312, the card 312 is displayed with map content that visualizes route and/or service locations for the service provider. The card 312 that is presented in the focus mode can be the highest priority card 312, such as the card 312 representing an exclusive or guaranteed job order that is matched to the service provider. The service provider can interact with the response feature 315 to accept the represented job order, in which case the computing device 302 transmits the response communication to the network system 100, and the network system 100 automatically assigns the job order to the service provider. Subsequently, as shown in FIG. 3K, the user interface 300 is transitioned to showing navigation content 335 for navigating the service provider to the service location(s) of the job order. Once the service provider is assigned to the job order, all of the open cards 312 of the service provider are dismissed, such that no other card is viewable until the service request represented by the card 312 is accepted or dismissed. Alternatively, the service provider can dismiss the card 312 shown in FIG. 3J, in which case the device 302 transmits a response communication that indicates the service provider has declined the matched job order. The network system 100 may then refresh or transmit another card (e.g., another exclusive or guaranteed job order) to the computing device 302.

FIG. 3L through FIG. 3O illustrate a first sequence of events following a service provider selecting a non-exclusive card 312. In FIG. 3L, the service provider can interact with the response feature 315 of the card to select the job order represented by the card 312. In response, the computing device 302 transmits the selection communication to the network system 100. In the case where the selected job order is non-exclusive, the network system can implement a decision-making process or determination as to assign or not assign the service provider to the job order. For example, if the service provider is the only service provider to accept the job order, then the system 100 may assign the service provider to the represented job order. FIG. 3M illustrates an interstitial state where the network system 100 implements the decision-making process or determination. After completing the decision-making process, if the network system 100 assigns the job order to the service provider, the user interface 300 displays the assignment (FIG. 3N) and the user interface 300 transitions to displaying map content 335 without cards 312 (FIG. 3O). The other cards 312 may be dismissed.

FIG. 3P through FIG. 3S illustrate a second sequence of events following a service provider selecting a non-exclusive card 312, where the second sequence illustrates events where the service provider selects a group-matched or non-exclusive job order (FIG. 3P), is provided an interstitial (FIG. 3O) while the decision-making process is carried out, and then informed that they were not assigned to the job order represented by the selected card. In some examples, the user interface 300 provides map content, with a feature 339 the service provider can select to view the cards 312 of other matched job orders. In variations, when the service provider selects a non-exclusive job order but is not assigned to the job order in the subsequent decision-making process by the network system 100, the other open cards 312 (representing job orders) are dismissed. The service provider can interact with the feature 339 (FIG. 3S) to receive job order data for an updated or new set of job orders.

FIG. 3T through FIG. 3V illustrate an example sequence of cards that can be displayed on a provider device 104. The user interface 300 can arrange cards, representing available multiple job orders, in the form of a stack 320. In the example shown, each job order of the stack 320 is a group-matched or non-exclusive job order. In examples, the user interface 300 includes processes to generate a card for each job order that is received on the provider device 104. In some examples, each card 312 is associated with a priority or ranking that reflects, for example, a value of the job order, a proximity of a service location of the job order to a location of the user, or other parameter. Each card 312 can also be associated with a display state. The display state can include “displayed” meaning the top or surfaced card of the stack is made visible to the provider. Additionally, the display state can include “occluded,” meaning that the card 312 is to be at least partially hidden behind at least one other card (e.g., the top card). Still further, a card can be associated with a display state of “hidden” which can be used for a card other than the displayed card, a bottom card and/or a card that has been closed or dismissed. When the user interface 300 is switched to a grid view, the display state of each card can be switched to “displayed” such that each card 312 is concurrently visible.

As an addition or variation, each card 312 can be associated with a layer, with the surfaced card being provided on the foreground layer, and each subsequent layer being one level in the background. Each card may be assigned to a layer. Initially, the assignment may be based on a priority or ranking of the cards, with the foreground layer being assigned the highest priority/rank card. The cards 312 may be displayed by the user interface 300 to be slightly offset, such that an overlapping portion of a card that underlies another card is occluded by the other card, while a portion that is not underlying another card is visible. This type of offset between cards 312 of different layers can provide an illusion of thickness that correlates to the number of cards. When the user navigates with respect to the stack 320, the layer associated with a particular card 312 may be changed, such that the layer matches the position of the card in the stack. For example, a newly surfaced card may appear in the layer that is in the foreground. When the cards are switched into a grid view, the cards 312 may be displayed on a common layer so that the cards 312 are concurrently visible.

In FIG. 3T, the provider can interact with the surfaced card 312A by selecting the response feature 315 to confirm acceptance of the represented job order. In turn, the provider device 104 communicates the service provider's selection to the network system 100, where the network system 100 performs a selection process to determine whether the provider is to be assigned to the job order represented by that card 312.

In examples, following the service provider interacting with the user interface 300 to select a group-matched or non-exclusive job order, the service provider can select another group-matched or non-exclusive job order. The service provider can continue to select group-matched or non-exclusive job orders until the provider is assigned to one of the group-matched or non-exclusive job orders that he or she selected. Once the service provider selects the response feature 315 of the surfaced card 312A (signifying his acceptance or selection of the matched job order), he can navigate to a next card 312B (FIG. 3U) of the stack 320 to view and potentially accept the group-matched or non-exclusive job order of the next card. For example, the service provider can swipe (e.g., provide a touch input on the touch-display of the device in a direction corresponding to the layout of the cards) to navigate to the next card 312B. Alternatively, the service provider can select the next card by choosing the direction of his or her swipe—a left swipe may navigate through the stack 320 in one direction, and a right swipe may navigate through the stack 320 in another direction. Still further, in some examples, once the service provider selects a matched job order (e.g., group-matched or non-exclusive job order), the user interface 300 can automatically navigate to the next card 312B (FIG. 3U) in the stack 320. In FIG. 3U, the service provider can interact with the selection feature 315 of the card 312B, and in response, the user interface 300 can automatically surface another next card 312C, and this process can be repeated for additional surfaced cards until the network system 100 assigns the service provider to one of the job orders represented by a card that the service provider selected, or until no other matched job orders remain for that service provider.

In examples, when the service provider interacts with the user interface 300 to select a group-matched or non-exclusive job order, the job order can be designated as having a pending status, meaning that the network system 100 has yet to assign the job order to a service provider of the group who selected the job order. In examples, the user interface 300 can track and display the number of job orders the service provider has pending. The user interface 300 can include a feature 318 that indicates, for example, (i) whether or not the service provider has a job order with a pending status, and/or (ii) the number of job orders which the service provider has with the pending status. As shown in FIG. 3U and FIG. 3V, for example, the feature 318 can display a count of the number of job orders which are pending for the service provider, corresponding to group-matched or non-exclusive job order(s) which the service provider selected but which the network system 100 has yet to assign to any service provider. When the network system 100 assigns a job order that is pending for one service provider to another service provider, the network system 100 may communicate with the user interface 300 to update (e.g., decrement) the count displayed with the feature 318. Likewise, if one of the pending job orders for a service provider is canceled (e.g., requester cancels the service request), the network system 100 can communicate with the user interface 300 to reduce the count of the feature 318 accordingly, indicating the corresponding job order is no longer available. In this regard, the feature 318 may be dynamic, in that the count displayed by the feature 318 represents the number of group-matched or non-exclusive job orders that the particular service provider selected (via interaction with the response feature 315) and which remain unassigned and open at a particular moment.

Among other advantages, by enabling individual service providers to select multiple matched job orders, a greater number of service providers become available for each represented job order. Service providers do not have to weigh the advantages or disadvantages of each job order before making a selection. Further, the service provider does not have to navigate through the entire stack 320 to choose which job order he or she wants to be considered for. Rather, the service provider can accept each job order that is acceptable to that service provider. The subsequent selection process that is performed by the network system 100 can better optimize the subsequent selection process when pairing service provider to job order, as a greater number of service providers can be considered as candidates for each job order.

In examples, the user interface 300 can accept different types of input to manage the stack 320. The cards 312 of the stack can be eliminated from the stack 320 once the service provider performs an action on the card. The action can correspond to a positive response, a negative response or dismissal, or a neutral action. A positive response can correspond to the service provider interacting with the selection feature 315 to signal that the service provider is interested in the group-matched or non-exclusive job order. In response to the positive response, the user interface 300 removes that card from the stack 320. Further, in response to the positive response, the network system 100 includes that service provider in the selection process for determining which service provider to assign to the corresponding job order. A negative response can correspond to the service provider dismissing the card, by, for example, interacting the with the dismissal feature 319. In response to the negative response, the user interface 300 removes the card 312 from the stack 320, and the network system 100 does not include the service provider in the selection process for the corresponding job order. A neutral response can correspond to the service provider swiping or navigating to another card 312 in the stack 320 without interacting with the response feature 315 or dismissal feature 319.

In examples, once the service provider provides input for the negative response (e.g., selects the dismissal feature 319), the service provider is not subsequently provided the job order. For example, the network system 100 may record the service provider as declining the job order. When a job order is unassigned for a given time interval, it may be subject to multiple instances of being group-matched until a suitable service provider is assigned. However, in examples, once a service provider declines the job order, the network system 100 may remove the service provider from a candidate list in subsequent instances when the group match is performed. Still further, in some examples, the network system 100 may elevate a previously group matched job order to an exclusive job order. In doing so, the service provider(s) who declined the job order (e.g., through interaction with the dismissal feature 319) may be removed as a candidate when the matching is performed to see which service provider received the job order as an exclusive offer. Still further, in some examples, when the service provider declines a group-matched or non-exclusive offer, the card representing the job order is removed from the stack 320 but may be returned if a condition is met. For example, a previously declined job order can be returned to the stack 320 in response to a condition such as (i) the service provider's position changing, where the service provider moves closer to the service start location for the job by more than a threshold amount (e.g., closer by one mile); (ii) the value (e.g., fare) for the job order increases; (iii) passage of time, where, for example, the service provider does not receive an assignment or has no job orders to consider, and/or (iv) some other condition where the job order may be deemed more attractive to the service provider.

### Hardware Diagram

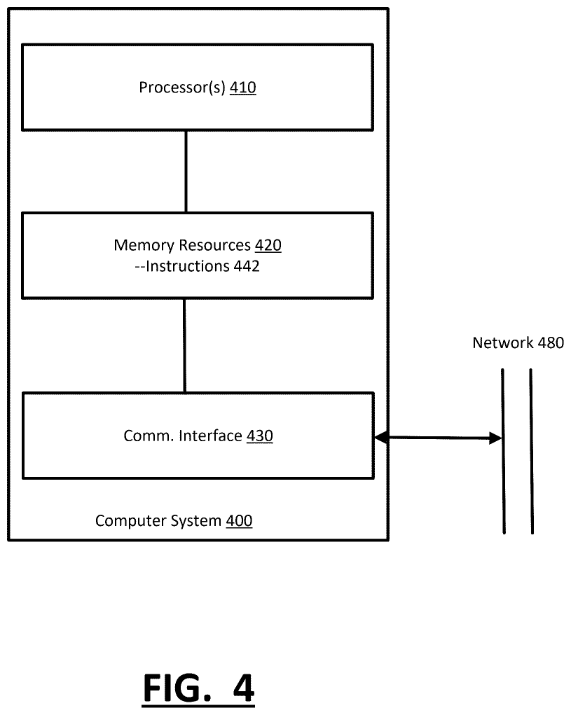

FIG. 4 is a block diagram that illustrates a computer system upon which one or more embodiments described herein may be implemented. For example, in the context of FIG. 1A, the network system 100 may be implemented using a network computer system or combination of network computer systems, such as described with an example of FIG. 4. Additionally, methods such as described with examples of FIG. 2A be implemented using a computer system such as described with an example of FIG. 4.

In one implementation, the computer system 400 includes one or more processors 410, memory resources 420, and a communication interface 430. The computer system 400 includes at least one processor 410 for processing information. The memory resources 420 may include a random-access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 442 for implementing a network system 100, such as described with an example of FIG. 1A. Additionally, the processor(s) 410 can execute the instructions 442 to implement methods such as described with example methods of FIG. 2A.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive transport requests from requester devices via the network link 480. Additionally, the computer system 400 can receive information from provider devices, from which forecasts of provisioning levels, location bias and other aspects described herein may be determined.

Examples described herein are related to the use of the computer system 400 for implementing the techniques described herein. According to one embodiment, those techniques are performed by the computer system 400 in response to the processor 410 executing one or more sequences of one or more instructions contained in the memory resources 420. Such instructions may be read into the memory resources 420 from another machine-readable medium, such as the storage device. Execution of the sequences of instructions contained in the memory resources 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Provider Device

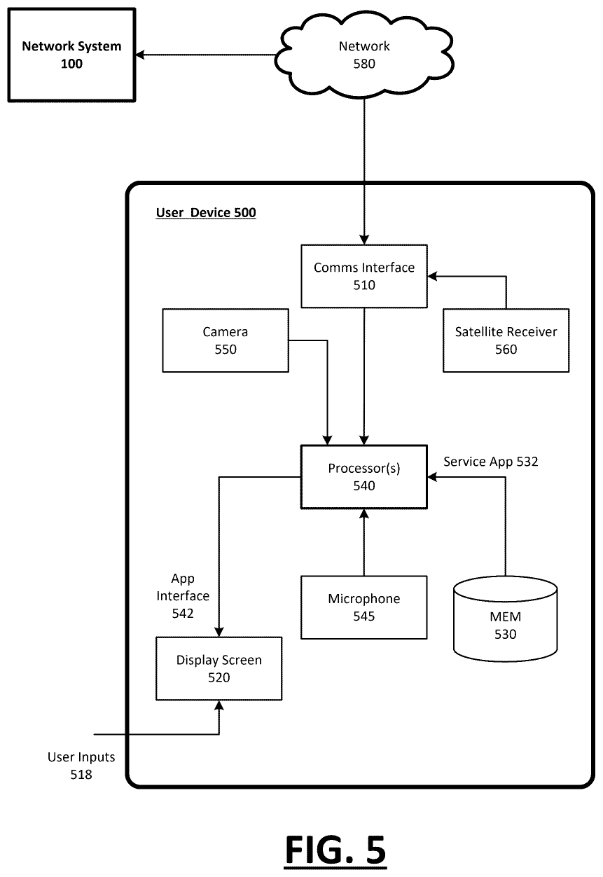

FIG. 5 is a block diagram illustrating an example user device for use with examples as described. In an example, a user device 500 may be implemented as a service provider device 104 that executes a designated service application 108 on which a job handling interface system 150 (see FIG. 1b) is provided. In many implementations, a user device 500 can include a mobile computing device, such as a smartphone, tablet computer, laptop computer, VR or AR headset device, and the like. As such, the user device 500 can include typical telephony and/or tablet features such as a microphone 545, a camera 550, a satellite receiver 560, and a communication interface 510 to communicate with external entities using any number of wireless communication protocols. In certain aspects, the user device 500 can store a designated application (e.g., a service app 532) in a local memory 530. In variations, the memory 530 can store additional applications executable by one or more processors 540 of the user device 500, enabling access and interaction with one or more host servers over one or more networks 580.

In response to a user input 518 (e.g., input for cards, input to select response feature), the service application 532 can interact with the user device 500 to display an interface for a multi-modal user interface on the display screen 520. When the user device 500 is used as a requester device, the application executes to provide a multi-modal user interface, with interfaces such as shown with examples of FIG. 3A through FIG. 3V.

### CONCLUSION

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A non-transitory computer-readable medium that stores instructions, which when executed by one or more processors of a computing device, cause the computing device to perform operations that include:
communicating, over one or more networks, with a network system to receive job order data for a plurality of job orders, the job order data including each of service information for each of the plurality of job orders, and one of multiple priority designations associated with each of the plurality of job orders; and
providing a user interface to display the service information for each job order of the plurality job orders, the user interface being provided in one of multiple modes at a given time, the multiple modes including (i) a focus mode in which service information for only one of the plurality of job orders is displayed at a time, the job order being pre-selected based on the priority designation of that job order; and (ii) a browse mode in which the service information for multiple job orders of the plurality of job orders is displayed at one time.

2. The non-transitory computer-readable medium of claim 1, wherein the operations further comprise:
detecting one or more conditions; and
automatically implementing one of the focus mode or the browse mode in response to detecting the one or more conditions.

3. The non-transitory computer-readable medium of claim 2, wherein detecting the one or more conditions includes detecting that the computing device is in a moving vehicle.

4. The non-transitory computer-readable medium of claim 3, wherein detecting that the computing device is in the moving vehicle is based on sensor input from one or more sensors of the computing device.

5. The non-transitory computer-readable medium of claim 1, wherein the user interface includes a plurality of cards, each of the plurality of cards including service information for a corresponding job order of the plurality of job orders, and wherein each card includes or is associated with a feature for enabling the user to transmit a response communication to the network system for the corresponding job order.

6. The non-transitory computer-readable medium of claim 5, wherein in the focus mode, the plurality of cards are arranged in a stack that allows the user to view service information provided on one card at a time.

7. The non-transitory computer-readable medium of claim 6, wherein user interface enables the user to interact with one card at a time to navigate through the stack and view individual cards of the plurality of cards.

8. The non-transitory computer-readable medium of claim 6, wherein the plurality of cards are ordered in the stack in accordance with the priority designation of each of the plurality of job orders.

9. The non-transitory computer-readable medium of claim 6, wherein in the browse mode, the plurality of cards are arranged to allow the user to view service information provided on multiple cards at one time.

10. The non-transitory computer-readable medium of claim 5, wherein the operations further comprise:
detecting a user activity with respect to individual cards of the plurality of cards, the user activity indicating whether the user has viewed or not viewed the service information of the card; and
transmitting activity data that indicates the user activity data to the network system.

11. A network system comprising:
one or more processors;
a memory to store a set of instructions;
wherein the one or more processors execute the instructions to perform operations that include:
identifying a plurality of service providers for matching, each service provider of the plurality of service providers operating a corresponding service provider device that transmits location information to the network system;
identifying a plurality of job orders for matching, each job order of the plurality of job orders including service information that includes one or more service locations indicated in a corresponding transport service request; and
matching each service provider of the plurality of service providers with multiple job orders of the plurality of job orders, wherein for each service provider of the plurality of service providers, matching includes associating one of multiple priority designations for each matched job order, the multiple priority designations including an exclusive priority designation in which the associated job order is matched to only one service provider of the plurality of service providers; and
transmitting, over one or more networks, a corresponding set of job order data to the associated service provider device of each of the plurality of service providers, wherein for each of the plurality of service providers, the corresponding set of job order data transmitted to the associated service provider device includes the service information and the associated priority designation of each of the multiple job orders that are matched to that service provider.

12. The network system of claim 11, wherein for each service provider of the plurality of service providers, making a determination as to whether the service provider is or is not interested in one or more job orders of the multiple job orders that are matched to that service provider; and
wherein transmitting the corresponding set of job order data to the associated service provider device of each of the plurality of service providers includes transmitting updated job order data to the associated service provider device of each of one or more service providers based on the determination made for that service provider as to whether the service provider is or is not interested in the one or more job orders of the multiple job orders.

13. The network system of claim 11, wherein making the determination includes receiving, over one or more networks, job order activity data from the associated service provider device of a first service provider, the job order activity data indicating that the first service provider viewed or navigated past, but did not act, on a first job order of the multiple job orders that is matched to the first service provider.

14. The network system of claim 13, wherein the updated job order data transmitted to the associated service provider device of the first service provider excludes job order data for the first job order.

15. The network system of claim 11, wherein the multiple priority designations include a non-exclusive priority designation in which the associated job order is matched, or designated to be concurrently matched, to multiple service providers of the plurality of service providers during a matching time interval.

16. The network system of claim 11, wherein the corresponding set of job order data causes the associated service provider device of each of the plurality of service providers to preselect the service information of the matched job order that is associated with the exclusive priority designation for display on a priority user interface panel.

17. The network system of claim 11, wherein matching includes matching each service provider to no more than one job order having the exclusive priority designation, such that each job order having the exclusive priority designation is matched to only one service provider of the plurality of service providers.

18. The network system of claim 11, wherein the operations include:
receiving, over one or more networks, a response communication from the associated service provider device of a first service provider of the plurality of service providers, the response communication indicating that the first service provider accepts a first job order having the exclusive priority designation; and
in response to receiving the response communication, assigning the first service provider to the first job order.

19. The network system of claim 15, wherein the operations include:
receiving, over one or more networks, a response communication from the associated service provider device of a first service provider, the response communication indicating the first service provider accepts a first job order having the non-exclusive priority designation; and
in response to receiving the response communication, making a determination as to whether to assign the first service provider or another service provider to the first job order.

20. The network system of claim 11, matching the plurality of service providers to the plurality of job orders based on the location information transmitted by the associated service provider device of each of the plurality of service providers, and the service information of each of the plurality of job orders.

21. The network system of claim 20, wherein the service information of the individual job orders includes one or more service locations identified with the corresponding transport service request.

22. The network system of claim 11, wherein the operations include:
initiating, for the associated service provider device of each of the plurality of service providers, a timer that provides a time interval for each service provider to provide a response communication to accept or select one of the multiple job orders that are matched to the service provider, before transmitting the updated job order data to the associated service provider device.
